(19) United States
(12) Patent Application Publication
(10) Pub. No.: US 2007/0173248 A1
(43) Pub. Date: Jul. 26, 2007

(54) System and method for analyzing a wireless connection

(76) Inventor: Ramesh Sekhar, San Jose, CA (US)

Correspondence Address: FAY KAPLUN & MARCIN, LLP, 15O BROADWAY, SUITE 702, NEW YORK, NY, 10038, US

(21) Appl. No.: 11/336,456

(22) Filed: Jan. 20, 2006

(51) Int. Cl. H04Q 7/20

(52) U.S. Cl. 455/423

(57) ABSTRACT

Described is a system and method for analyzing a wireless connection. The method comprises receiving input data corresponding to communications between a mobile unit and a first access point. The input data is classified into at least one of a first plurality of sets, each set corresponding to a range of values for the input data. Output data is determined based on the input data, wherein a second plurality of sets, each set corresponding to a range of values for the output data, is derived by applying rules to the first plurality of sets. The output data is a solution space of a subset of the range of values within at least one of the second plurality of sets. One of the subset of the range of values in the solution space is selected.

### FIELD OF THE INVENTION

The present invention relates to wireless communications between electronic devices and, in particular, to a system and method for analyzing a wireless connection.

### BACKGROUND INFORMATION

conventional wireless network frequently includes multiple access points (“APs”) deployed in various geographical locations in order to maximize radio frequency (“RF”) coverage of the network. As a mobile unit (“MU”) moves from a first location to a second location within the network, the MU may switch wireless communications by terminating communication with a first AP and initiating communication with a second AP. A switch by the MU from the first AP to the second AP is generally referred to as a “roam”.

A conventional roaming operation compares current network data to roaming thresholds, which are discrete values utilized by the MU for determining when to perform the roam. When the current network data exceeds one of the roaming thresholds, the MU performs the roam. The roaming thresholds are typically tuned over time to optimize the roaming operation. For example, slight differences in a broadcast power of an AP arising from a variation caused by a manufacturing process may necessitate an adjustment of one of the roaming thresholds for the MU. When an unforseen scenario presents itself, the roaming thresholds must be re-tuned, leading to interruptions of service. In addition, in applications such as voice-over-IP, where interruptions in service (e.g., dropped data packets) can be detected by a user, the roaming thresholds must be tuned even more finely than in other applications. Therefore, there is a need for an improved roaming operation which is time and cost efficient.

### SUMMARY OF THE INVENTION

The present invention relates to a system and method for analyzing a wireless connection. The method comprises receiving input data corresponding to communications between a mobile unit and a first access point. The input data is classified into at least one of a first plurality of sets, each set corresponding to a range of values for the input data. Output data is determined based on the input data, wherein a second plurality of sets, each set corresponding to a range of values for the output data, is derived by applying rules to the first plurality of sets. The output data is a solution space of a subset of the range of values within at least one of the second plurality of sets. One of the subset of the range of values in the solution space is selected.

### BRIEF DESCRIPTION OF THE DRAWINGS

FIG. 1 is an exemplary embodiment of a system according to the present invention;

FIG. 2 is an exemplary embodiment of a method according to the present invention;

FIG. 3 is an exemplary embodiment of a first membership function according to the present invention;

FIG. 4 is an exemplary embodiment of a second membership function according to the present invention;

FIG. 5 is an exemplary embodiment of a combined membership function according to the present invention; and

FIG. 6 is an exemplary embodiment of a computing device according to the present invention.

### DETAILED DESCRIPTION

The present invention may be further understood with reference to the following description and the appended drawings, wherein like elements are provided with the same reference numerals. The present invention provides a system and a method for analyzing a wireless connection utilized by a wireless device to a wireless network. An exemplary embodiment of the present invention will be described in the context of a wireless local area network (“WLAN”), however, one skilled in the art will understand that the present invention is not limited to such an environment, but may be utilized in other wireless environments (e.g., a wireless wide-area network, “WWAN”).

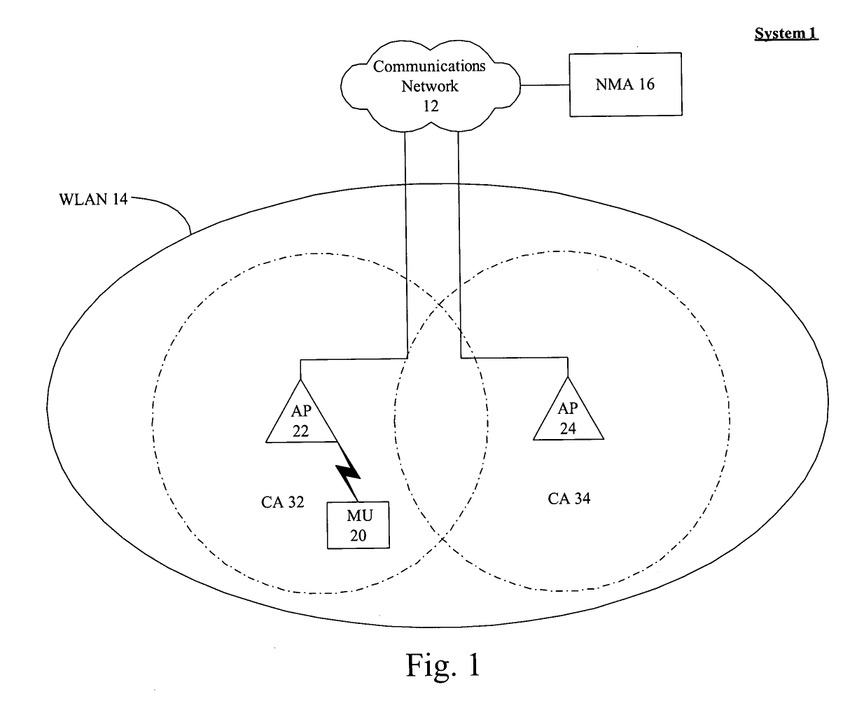

FIG. 1 shows an exemplary embodiment of a system 1 for wireless communications according to the present invention. The system 1 may include a network management arrangement (“NMA”) 16 coupled to a communications network 12. The NMA 16 may include one or more computing devices (e.g., a server, a database, etc.) for sending and receiving data requests and may also be responsible for managing the network 12 and any devices coupled thereto. The network 12 may be any communications network which interconnects the NMA 16 and devices in a WLAN 14. For example, the network 12 may include one or more network devices (e.g., a switch, a router, a server, a hub, etc.). The network 12 may allow one or more WLANs to access the NMA 16 or any other device and/or communications network (e.g., a separate WLAN (not shown)) coupled thereto.

The WLAN 14 may include one or more access points (“APs”) 22, 24 which provide a wireless connection for a mobile unit (“MU”) 20 to the network 12. Those skilled in the art will understand that the WLAN 14 may include any number of APs and MUs. The MU 20 may be any mobile computing unit (e.g., a cell phone, a PDA, a laptop, a network interface card, a handheld computer, etc.) capable of communicating wirelessly with the APs 22, 24. The MU 20 may include an image based barcode scanner, a laser based barcode scanner and/or an RFID reader.

In one embodiment of the present invention, the MU 20 may initially be communicating with the AP 22. Those of skill in the art will understand that the MU 20 may also access the AP 24. That is, the MU 20 may be capable of transmitting/receiving signals to/from the AP 24 while it is currently communicating with the AP 22.

Each AP 22, 24 may have a corresponding coverage area (“CA”) which defines a region in which RF signals may be transmitted and received by the AP. For example, the AP 22 may have a CA 32 and the AP 24 may have a CA 34. As shown in FIG. 1, the MU 20 is located within the CA 32 and may thus access the AP 22. The CAs 32, 34 may also overlap to define a region within the WLAN 14 in which the MU 20 may access both the APs 22, 24. As a user moves throughout the WLAN 14, the MU 20 may move from one coverage area (e.g., CA 32) to another (e.g., CA 34), experiencing a change in wireless coverage with respect to each AP 22, 24. For example, as the MU 20 moves away from the CA 32, the MU 20 may experience a decreased ability to communicate (e.g., reduced signal strength) with the AP 22, thereby necessitating a roaming operation.

In the exemplary embodiment, the MU 20 may utilize fuzzy logic to perform a roaming analysis, which determines whether the roaming operation should be performed. In performing the roaming analysis, the MU 20 may utilize one or more membership functions. The membership functions may provide graphical representations of a degree of membership (“DOM”) of an input data in a set of one or more variables (e.g., fuzzy variables). The membership functions may be stored temporarily (e.g., in a cache) or stored permanently (e.g., in a memory). In other embodiments, the membership functions may be implemented as one or more circuits (e.g., an application-specific integrated circuit) disposed in the MU 20. The membership functions and the roaming analysis will be described in detail below.

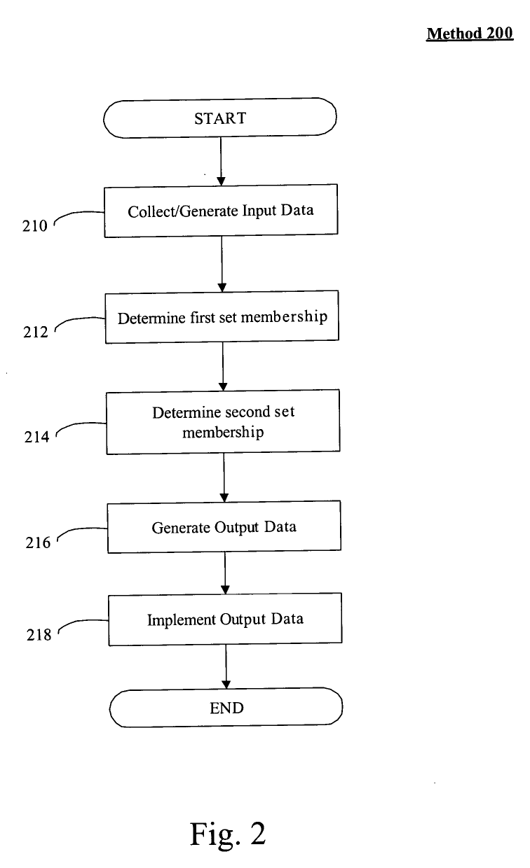

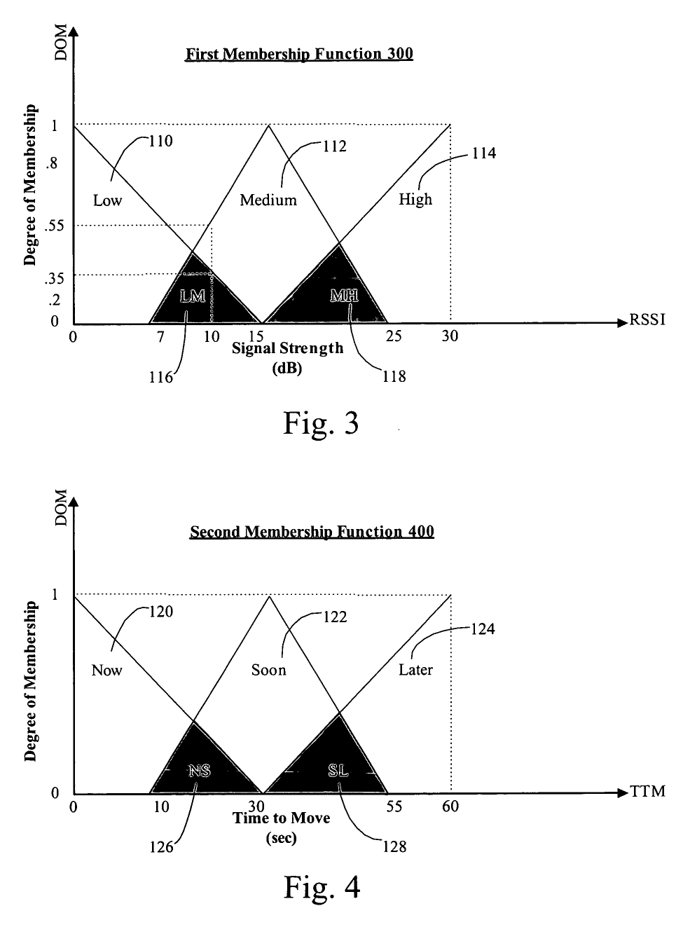

FIG. 2 shows an exemplary embodiment of a method 200 for analyzing the wireless connection between the MU 20 and the AP 22 according to the present invention, which will be described in conjunction with FIGS. 3-5. In the exemplary embodiment, the method 200 may be implemented by the MU 20. However, in other embodiments, the method 200 may be implemented at any device which has network management capabilities such as, for example, the APs 22, 24, a centralized switch, the NMA 16, etc.

In step 210, the input data is generated by the MU 20. The input data may include signal-related information, such as a received signal strength indicator (“RSSI”), latency, response time, etc. The input data may be generated by the MU 20 after collecting the signal-related information from an AP with which it is currently communicating (e.g., AP 22). For example, the MU 20 may generate the input data in response to a communication from the AP 22. The input data may be generated, for example, when a data transmission occurs, or when the MU 20 responds to a signal transmitted by the AP 22 (e.g., a beacon signal), at a constant polling rate, etc. In some embodiments, generation of the input data may be manual, such as when the user directs the MU 20 to transmit a signal (e.g., a probe signal) to the AP 22. The input data may also be generated in response to data collected from any AP within communication range of the MU 20 (e.g., APs 22, 24). In other embodiments, the MU 20 may not generate the input data. For example, each of the APs 22, 24 may generate the input data, which may then be transmitted to the MU 20.

In step 212, the MU 20 determines a first set membership based on the input data by mapping the input data onto a first membership function 300 which is shown in FIG. 3. A membership function for a variable (input data) divides all possible values of the variable into overlapping sets. Each of these sets describe a particular range of values of the input data. For example, if the input data includes the RSSI, the MU 20 may determine the DOM of the input data in each of a first set variable (e.g., Low 110), a second set variable (e.g., Medium 112), and/or a third set variable (e.g., High 114). The set variables 110-114 may describe the input data. For example if the input data includes the RSSI value, an RSSI value of 2 may be described as “Low”, an RSSI value of 15 may be described as “Medium”, and an RSSI value of 30 may be described as “High”. In one embodiment, the set of variables may be defined as a series of triangular regions on the membership function 300. However, each set variable may be any geometric shape (e.g., a trapezoid, a rectangle, exponential, a polygon, etc.) which achieves a desired response. Those of skill in the art will understand that a processing time of the roaming analysis may be decreased when the set of variables is defined by shapes with linear sides (e.g., a triangle).

As shown in FIG. 3, the set variables Low 110, Medium 112, and High 114 may intersect. For example, the set variables Low 110 and Medium 112 may form an intersection LM 116, and the set variables Medium 112 and High 114 may form an intersection MH 118. Thus, the input data may be identified with more than one set variable if it corresponds to one of the intersections LM 116 and/or MH 118. The DOM may be calculated by locating a point or a plurality of points at which the input data intersects the set of variables. For example, as shown in FIG. 3, the input data with an RSSI value of 10 decibels will have DOM values of 0.35 in the set variable Low 110, 0.55 in the set variable Medium 112, and 0 in the set variable High 114. Thus, the input data with the RSSI value of 10 decibels is a member of the set variables Low 110 and Medium 112, but is not a member of the set variable High 114.

Those of skill in the art will understand that by allowing the input data to be a member of more than one set variable, the method 200 enables the MU 20 to perform the roaming analysis without being limited to a single threshold value, which may be advantageous in situations where the single threshold value results in undesirable performance. For example, the AP 22 may, as a result of manufacturing variations, produce signal strengths which deviate from a normal signal strength, which in turn causes the input data to deviate. The MU 20 may also be subject to manufacturing variations, which may affect a sensitivity with which the MU 20 collects the input data, further contributing to the input data deviation. Thus, the roaming analysis should take these deviations into consideration. For example, as shown in FIG. 3, if the input data has a normal RSSI value of 10 decibels, but has an actual value between 7 and 13 decibels, the actual values of 7 and 13 decibels will both correspond to the intersection LM 116. That is, the input data will have memberships in the set variables Low 110 and Medium 112 regardless of whether the actual value is between 7 or 13 decibels. Thus, the roaming analysis may utilize different input data values within a range of values and produce same or similar results. Accordingly, parameters of the membership function 300 (e.g., boundaries of a set variable, corresponding DOM values, etc.) may be configured to account for the deviations. The above example of a first membership function 300 showed the function for the input data RSSI. However, those of skill in the art will understand that membership functions may be defined for any type of input data.

In step 214, the MU 20 determines a second set membership as a function of the DOM in the first membership function 300 in step 212. As shown in FIG. 4, a second membership function 400 with an output representing a time to move (“TTM”) may include a second set of variables comprising a fourth set variable (e.g., Now 120), a fifth set variable (e.g., Soon 122), and a sixth set variable (e.g., Later 124) with an intersection NS 126 and an intersection SL 128. The set variables 120-124 may describe an output of the roaming analysis. That is, the output may be the TTM, which indicates an estimated time until the MU 20 executes the roaming operation. The second set membership may be determined by applying a set of rules upon the results of the determination in step 212. For example, a first rule may map the set variable Low 110 to the set variable Now 120 (i.e., if signal strength (RSSI) of current AP is low, find new candidate now), a second rule may map the set variable Medium 112 to the set variable Soon 122 (i.e., if signal strength (RSSI) of current AP is medium, find new candidate soon), and a third rule may map the set variable High 114 to the set variable Later 124 (i.e., if signal strength (RSSI) of current AP is high, find new candidate later). Thus, the input data with the RSSI value of 10 decibels and memberships in the set variables Low 110 and Medium 112 (FIG. 3) may have corresponding memberships in the set variables Now 120 and Soon 122 (FIG. 4). After determining the second set membership, the results of both set membership determinations are combined to produce an output of the roaming analysis as described below.

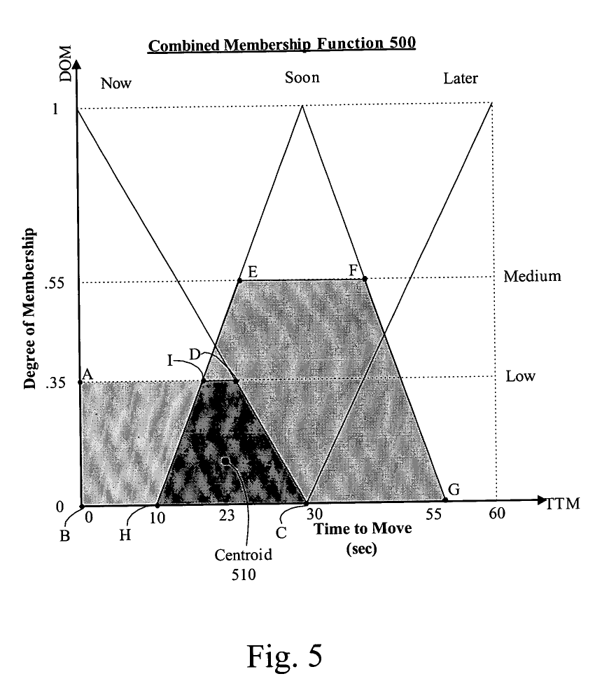

In step 216, the MU 20 generates an output data as a function of the input data and the first and second set memberships. The output data may include the TTM used by the MU 20 to complete the roaming analysis. Referring to FIG. 5, a combined membership function 500 is shown, which represents the second membership function 400 after the set of rules has been applied. According to one embodiment of the present invention, for the input data with the RSSI value of 10 decibels, the TTM value may be determined by finding a location of a centroid 510 of a combined solution space defined by points H-I-D-C. The combined solution space represents an intersection of a first solution space defined by points A-B-C-D and a second solution space defined by points H-E-F-G. As shown in FIG. 5, the first solution space may be defined by a boundary of the set variable Now 120 (e.g., AB, BC, CD) and the DOM in the set variable Low 110 (e.g., 0.35−AD). Similarly, the second solution space may be defined by a boundary of the set variable Soon 122 (e.g., HE, HG, GF) and the DOM in the set variable Medium 112 (e.g., 0.55−EF). Thus, for the input data with the RSSI value of 10 decibels, the location of the centroid 510 may indicate that the output data includes a TTM value of 23 seconds. The TTM value may be located anywhere within the boundaries of the combined solution space, and in other embodiments, the TTM value may not be determined using the centroid 510. For example, the TTM value may be an average of all possible TTM values within the combined solution space.

In step 218, the MU 20 implements the output data (e.g., the TTM). After a time equal to the TTM value has elapsed, the MU 20 may execute a roaming procedure, which may include a collection of input data (e.g., RSSI) from any AP the MU 20 is capable of accessing. The MU 20 may analyze the input data in order to make an association choice. For example, after 23 seconds has elapsed, the MU 20 may poll the APs 22, 24 and, depending on the input data collected, will either choose to communicate with the AP 24 or continue communicating with the AP 22.

In some embodiments, the MU 20 may also anticipate a rate at which the roaming analysis should be performed. For example, if the output data from the AP 22 indicates that the RSSI value is slightly low (e.g., the TTM value is 27 seconds), the MU 20 may increase a rate at which the roaming analysis is performed, thereby decreasing a response time. However, if the output data from the AP 22 indicates that the RSSI value is high, the MU 20 may decrease the roaming analysis rate, thereby conserving processing power.

Those skilled in the art will understand that the MU 20 may utilize any number of variable sets and corresponding membership functions and rules. For example, the MU 20 may use membership functions in which latency, loading, etc. are analyzed and corresponding output data values are generated. Thus, the output data may include multiple output values in addition to the TTM value. Accordingly, these output values may be used in step 218 to, for example, determine the appropriate AP, determine a power setting for transmissions, etc.

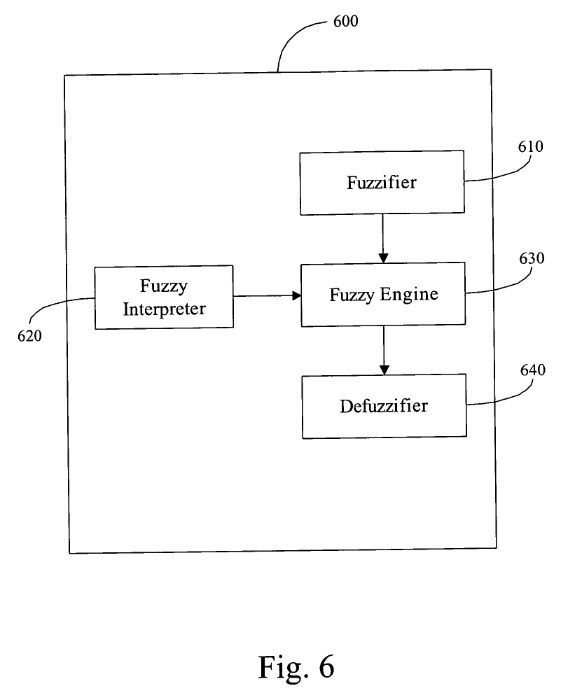

FIG. 6 shows an exemplary embodiment of a computing device 600 according to the present invention. The computing device 600 may be used to implement the method 200 described above and may include a fuzzifier 610 and a fuzzy interpreter 620, which are communicatively coupled to a fuzzy engine 630. The computing device 600 may also include a defuzzifier 640, which receives output from the fuzzy engine 630. Each of the components 610-640 may be implemented in hardware, software, or a combination thereof.

The fuzzifier 610 may be responsible for receiving the input data and determining the first set membership in accordance with steps 210 and 212 of FIG. 2. To effect the determination of the first set membership, the fuzzifier 610 may access data corresponding to the set variables Low 110, Medium 112, and High 114 in order to create the first membership function 300.

The fuzzy interpreter 620 may interpret the set of rules used to determine the second set membership by associating the set variables Low 110, Medium 112, and High 114 with the set variables Now 120, Soon 122, and Later 124. The rules may be accessed through an application program interface (“API) which is capable of obtaining the rules. The fuzzy interpreter 620 may also determine the second set membership in accordance with step 214 of FIG. 2.

The output of the fuzzifier 610 and the fuzzy interpreter 620 may be fed into the fuzzy engine 630, which may generate the output data and determine the combined solution space in accordance with step 216 of FIG. 2. After the combined solution space is determined, the defuzzifier 640 may determine the centroid 510. A roaming control API may then implement the output data according to step 218 of FIG. 2.

As described above, the exemplary embodiments of the present invention allow a developer or system administrator to define any number of fuzzy sets (membership functions for input data). The rules used to build the output data may then be abstracted from the defined sets allowing different sets of rules to be applied to handle different scenarios. For example, a VoIP application may use a different set of rules than a data application. These different rules may be applied to the same fuzzy sets of input data resulting in different output data based on the individual application. Thus, the abstraction of the rules from the fuzzy sets allows any number of rule sets to be applied without the overhead of defining corresponding input and output data for all of the rule sets.

Furthermore, the overlapping fuzzy sets of the exemplary embodiments reduces the need to finely tune the threshold values of the prior art. For example, the use of membership functions with membership in multiple set variables allows the roaming analysis to be performed as soon as the network is deployed, without having to adjust the roaming parameters each time the network is changed (e.g., when new APs are added to the network). In addition, since the defuzzification process is a result of averaging over a solution space, not all scenarios need to be specified. A broad set of rules can cover a wide range of scenarios allowing for a smooth transition between scenarios.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
receiving input data corresponding to communications between a mobile unit and a first access point;
classifying the input data into at least one of a first plurality of sets, each set corresponding to a range of values for the input data;
determining output data based on the input data, wherein a second plurality of sets, each set corresponding to a range of values for the output data, is derived by applying rules to the first plurality of sets, the output data being a solution space of a subset of the range of values within at least one of the second plurality of sets; and
selecting one of the subset of the range of values in the solution space.

2. The method of claim 1, further comprising:
controlling the mobile unit based on the selected value.

3. The method of claim 2, wherein the controlling includes a roam operation to find a new access point for communication.

4. The method of claim 1, wherein the input data includes one of a signal strength, an RSSI, a response time, a latency, a number of dropped packets, a traffic statistic, a data transfer rate and a number of retries.

5. The method of claim 1, wherein at least two of the first plurality of sets include overlapping ranges and wherein the input data is classified into the at least two of the first plurality of sets.

6. The method of claim 5, wherein the solution space includes the subset of the range of values in at least two of the second plurality of sets corresponding to the at least two of the first plurality of sets.

7. The method of claim 1, wherein the output data is a time to roam for the mobile unit.

8. The method of claim 1, wherein the subset of the range of values and the range of values are equal.

9. The method of claim 1, wherein the selecting one of the subset of the range of values includes selecting a mid-point value of the subset of the range of values in the solution space.

10. The method of claim 1, wherein each of the first plurality of sets include two dimensional data, a first dimension being the input data and a second dimension being a degree of membership, each of the second plurality of sets include two dimensional data, a first dimension being the output data and a second dimension being a degree of membership, wherein the solution space is a two-dimensional space in the at least one of the second plurality of sets.

11. The method of claim 10, wherein the selecting includes selecting a centroid in the two-dimensional solution space.

12. A computing device, including:
a fuzzifier receiving input data corresponding to communications between a mobile unit and a first access point and classifying the input data into at least one of a first plurality of sets, each set corresponding to a range of values for the input data;
a fuzzy interpreter receiving a set of rules and applying the set of rules to the first plurality of sets to create a second plurality of sets, each of the second plurality of sets corresponding to a range of values for output data;
a fuzzy engine determining a solution space within at least one of the second plurality of sets based on the input data, the solution space including a subset of the range of values of the at least one second plurality of sets; and
a defuzzifier to select one of the subset of the range of values of the at least one second plurality of sets.

13. The computing device of claim 12, wherein the mobile unit is controlled based on the selected value.

14. The computing device of claim 13, wherein the controlling includes a roam operation to find a new access point for communication.

15. The computing device of claim 12, wherein the input data includes one of a signal strength, an RSSI, a response time, a latency, a number of dropped packets, a traffic statistic, a data transfer rate and a number of retries.

16. The computing device of claim 12, wherein at least two of the first plurality of sets include overlapping ranges and wherein the input data is classified into the at least two of the first plurality of sets.

17. The computing device of claim 16, wherein the solution space includes the subset of the range of values in at least two of the second plurality of sets corresponding to the at least two of the first plurality of sets.

18. The computing device of claim 12, wherein the output data is a time to roam for the mobile unit.

19. The computing device of claim 12, wherein the subset of the range of values and the range of values are equal.

20. The computing device of claim 12, wherein the selecting one of the subset of the range of values includes selecting a mid-point value of the subset of the range of values in the solution space.

21. The computing device of claim 12, wherein each of the first plurality of sets include two dimensional data, a first dimension being the input data and a second dimension being a degree of membership, each of the second plurality of sets include two dimensional data, a first dimension being the output data and a second dimension being a degree of membership, wherein the solution space is a two-dimensional space in the at least one of the second plurality of sets.

22. The computing device of claim 21, wherein the selecting includes selecting a centroid in the two-dimensional solution space.

23. A computer system comprising a memory for storing a set of instructions and a processor for executing the set of instructions, the set of instructions being operable to:
receive input data corresponding to communications between a mobile unit and a first access point;
classify the input data into at least one of a first plurality of sets, each set corresponding to a range of values for the input data;
determine output data based on the input data, wherein a second plurality of sets, each set corresponding to a range of values for the output data, is derived by applying rules to the first plurality of sets, the output data being a solution space of a subset of the range of values within at least one of the second plurality of sets; and
select one of the subset of the range of values in the solution space.

24. An arrangement, comprising:
an input/output means for receiving input data corresponding to communications between a mobile unit and a first access point and classifying the input data into at least one of a first plurality of sets, each set corresponding to a range of values for the input data;
an interpreting means for receiving a set of rules and applying the set of rules to the first plurality of sets to create a second plurality of sets, each of the second plurality of sets corresponding to a range of values for output data;
a processing means for determining a solution space within at least one of the second plurality of sets based on the input data, the solution space including a subset of the range of values of the at least one second plurality of sets; and
a selecting means for selecting one of the subset of the range of values of the at least one second plurality of sets.
